(19) United States
(12) Patent Application Publication
(10) Pub. No.: US 2013/0327358 A1
(43) Pub. Date: Dec. 12, 2013

(54) CHIMNEY CLEANING APPARATUS AND METHOD

(71) Applicants: MEHMET DONDURUR, DHAHRAN (SA); AHMET Z. SAHIN, DHAHRAN (SA)

(72) Inventors: MEHMET DONDURUR, DHAHRAN (SA); AHMET Z. SAHIN, DHAHRAN (SA)

(73) Assignee: KING FAHD UNIVERSTIY OF PETROLEUM AND MINERALS, DHAHRAN (SA)

(21) Appl. No.: 13/493,894

(22) Filed: Jun. 11, 2012

(51) Int. Cl. F23J 3/02; B08B 1/00; B08B 5/04; A47L 9/00

(52) U.S. Cl. 134/8; 15/104.05; 15/347

(57) ABSTRACT

The chimney cleaning apparatus includes a soot-scraping scrubber attached to an adjustable handle. A receptacle is also attached to the handle for receiving the dislodged soot particles therein. In one embodiment, a vacuum system is attached to the receptacle for withdrawing the soot particles therefrom to facilitate cleanup. The apparatus can be adjusted to clean the chimney from hearth level or from roof level by switching the position of the soot-scraping scrubber and the receptacle.

### BACKGROUND OF THE INVENTION

1. Field of the Invention

The present invention generally relates to chimneys, and particularly to a chimney cleaning apparatus and method.

2. Description of the Related Art

Burning fossil fuels (wood, coal, etc.) in furnaces, stoves and fireplaces produces soot particles that coat the inside surfaces of flues and chimneys. The soot particles contain combustible materials that will readily ignite and burn under the proper conditions, often resulting in dangerous and damaging fires. Regular cleaning would prevent the buildup of soot on the interior walls of the chimneys and flues, thus lessening the chances of a dangerous fire.

There are many tools disclosed in the related art that are utilized for dislodging soot from the walls of chimneys and flues. Unfortunately, these tools have proven to be less than satisfactory, since they often involve dangerous ascents to the roof of a home or building and since they lack the ability to collect the dislodged soot, thereby assuring a messy cleanup. The art would certainly welcome a soot-cleaning apparatus that could be utilized from either the hearth or from roof level, and that would allow thorough chimney or flue cleaning while efficiently collecting dislodged soot. Thus, a chimney cleaning method and apparatus solving the aforementioned problems is desired.

### SUMMARY OF THE INVENTION

The chimney cleaning apparatus and method provides for effective chimney or flue cleaning. The apparatus includes a soot-scraping scrubber attached to an adjustable handle. A receptacle is also attached to the handle for receiving the dislodged soot particles therein. In one embodiment, a vacuum system is attached to the receptacle for withdrawing the soot particles therefrom to facilitate cleanup.

Accordingly, the invention presents a chimney/flue cleaning arrangement that is versatile, efficient and effective. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is a diagrammatic environmental perspective view of a first embodiment of a chimney cleaning apparatus according to the present invention, showing the apparatus configured for cleaning the chimney from hearth or fireplace level.

FIG. 2 is a diagrammatic environmental perspective view of the chimney cleaning apparatus of FIG. 1, showing the apparatus configured for cleaning the chimney from roof level.

FIG. 3 is a perspective view of the chimney cleaning apparatus of FIG. 1.

FIG. 4 is a diagrammatic environmental perspective view of a second embodiment of a chimney cleaning apparatus according to the present invention, showing the apparatus configured for cleaning the chimney from hearth or fireplace level.

FIGS. 5A and 5B are perspective views of alternative configurations of the soot collecting receptacle of a chimney cleaning apparatus according to the present invention.

FIG. 6 is a diagrammatic environmental perspective view of a third embodiment of a chimney cleaning apparatus according to the present invention, showing the apparatus configured for cleaning the chimney from hearth or fireplace level.

FIG. 7 is a diagrammatic environmental perspective view of the chimney cleaning apparatus of FIG. 6, showing the apparatus configured for cleaning the chimney from roof level.

FIG. 8 is an exploded perspective view of the chimney cleaning apparatus of FIG. 6.

Similar reference characters denote corresponding features consistently throughout the attached drawings.

### DETAILED DESCRIPTION OF THE PREFERRED EMBODIMENTS

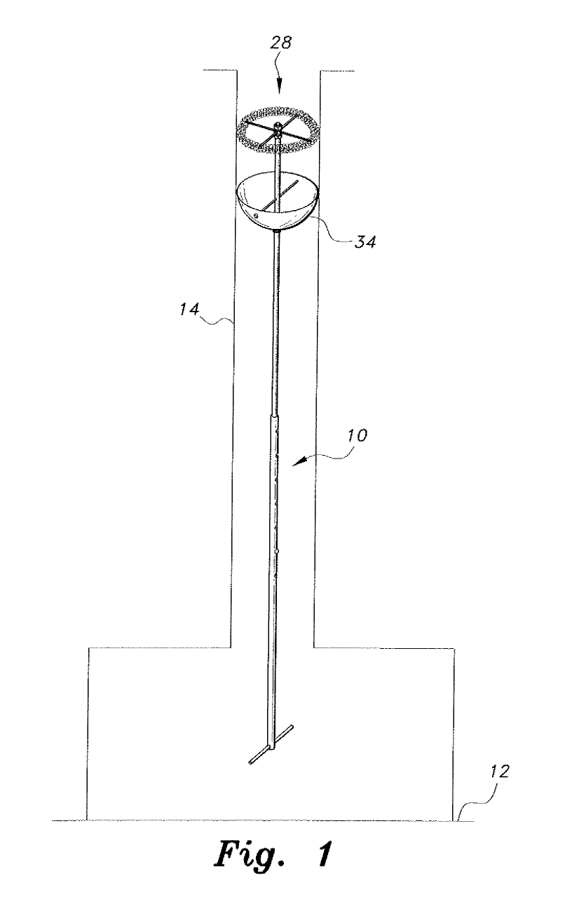

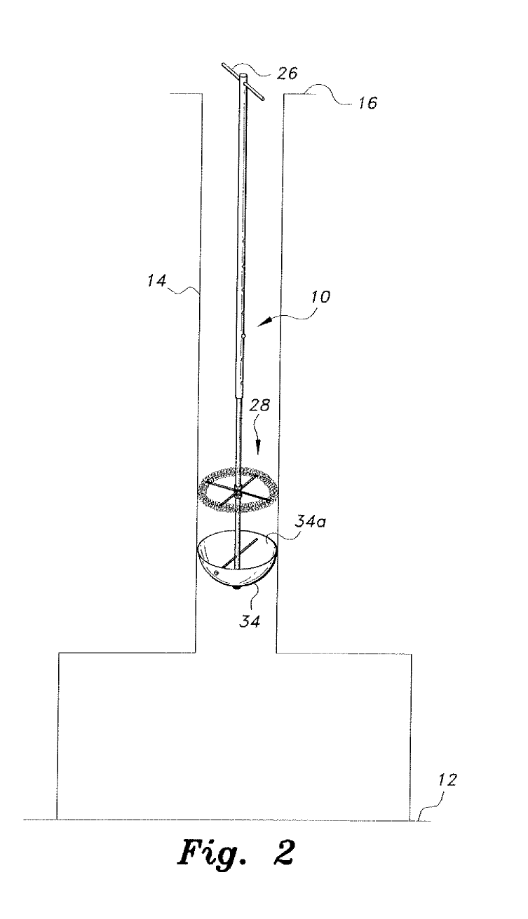

Referring to FIGS. 1 and 2, in a first embodiment, the chimney cleaning apparatus 10 may be alternately configured for cleaning a chimney or flue 14 either from below (i.e., from fireplace level) or from above (Le., from roof level). FIG. 1 shows how a user may employ the chimney cleaning apparatus 10 from hearth or fireplace level 12 to dislodge soot particles from the walls of a chimney or flue 14. FIG. 2 shows the cleaning being performed when the user is positioned at roof level 16.

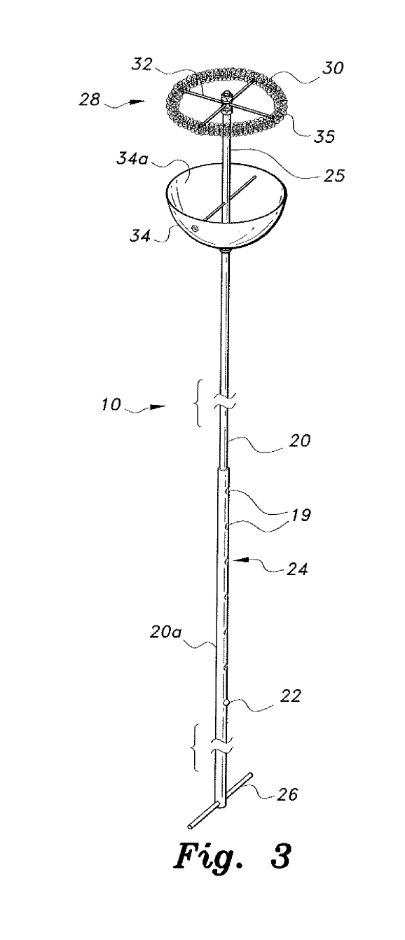

As best seen in FIG. 3, the chimney cleaning apparatus 10 comprises a pole handle 24 having a hollow telescoping section 20a that permits adjustability. A conventional spring-biased detent 22 is mounted in handle section 20 that selectively engages spaced-apart apertures 19 along the length of the hollow telescoping handle section 20a so that the handle 24 may be locked in a desired length when the cleaning process is performed. A handgrip or handle-manipulating member 26 is mounted on a proximate end of the telescoping handle section 20a to enhance manipulation thereof.

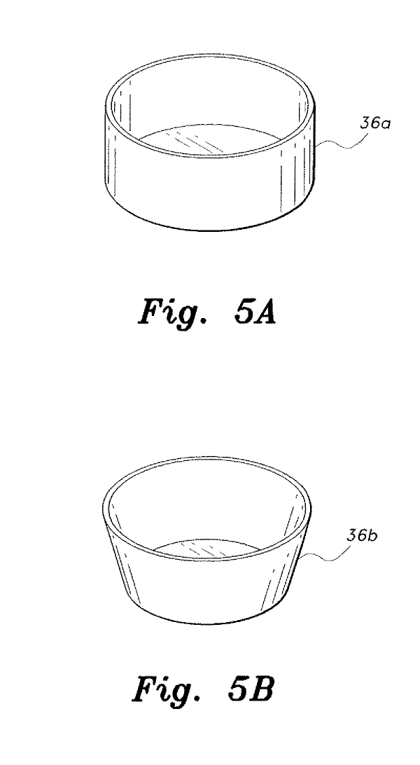

A soot-scraping scrubber 28 is adapted for removable attachment to the pole handle 24 in any conventional manner. The scrubber 28 comprises an annular ring 30 having radial spokes 32 extending from a hub having a connector for attaching the scrubber 28 to the pole handle 24. Metal scrubbing wires 35 (preferably stiff steel or copper filaments) are mounted to the entire circumferential edge of the ring 30. The scrubber 28 will have a diameter slightly smaller than the chimney or flue to be cleaned. A soot-collecting receptacle 34 is also adapted for removable attachment to the handle 24. The receptacle 34 is preferably of a circular, bowl-shaped configuration having a diameter slightly smaller than the diameter of the flue or chimney to be cleaned. The receptacle 34 defines a concave surface 34a that is provided to collect dislodged soot thereon. Although the circular configuration is preferred, it should be noted that other configurations may be utilized, such as (but not limited to) the receptacle 36a in FIG. 5A (a circular bottom and an annular wall extending 90° to the bottom) and the receptacle 36b in FIG. 5B (a circular bottom and a sloping annular wall extending from the bottom at an obtuse angle).

When using the tool for manually cleaning the chimney from ground or fireplace level (as shown in FIG. 1), the scrubber 28 is mounted on the distal end of the pole handle 24 and the receptacle 34 is mounted at a position between the proximal end and the distal end. When cleaning the chimney 14 from the roof (as shown in FIG. 2), the receptacle 34 will be mounted on the distal end of the handle and the scrubber 28 is mounted at a position between the proximate end and the distal end. In both instances the concave surface 34a of the receptacle 34 will face the scrubber 28. Interchangeability of the position of the scrubber 28 and the receptacle 34 may be provided in any conventional manner, e.g., by connecting the scrubber 28 and the receptacle 34 by a short handle extension 25 having male connectors at opposite ends (e.g., threaded studs, male quick connect couplers, etc.), by providing the scrubber 28 with a connector at the hub that has two female connectors (internally threaded sockets, female quick connect couplers, etc.) facing 180° opposite each other, and by providing the receptacle 34 with two female connectors (internally threaded sockets, female quick connect couplers, etc.) facing 180° opposite each other. Manipulating the tool up and down will cause the scrubber 28 to dislodge soot from the walls of the chimney or flue 14. The dislodged soot will fall into receptacle 34 for retrieval and proper disposal.

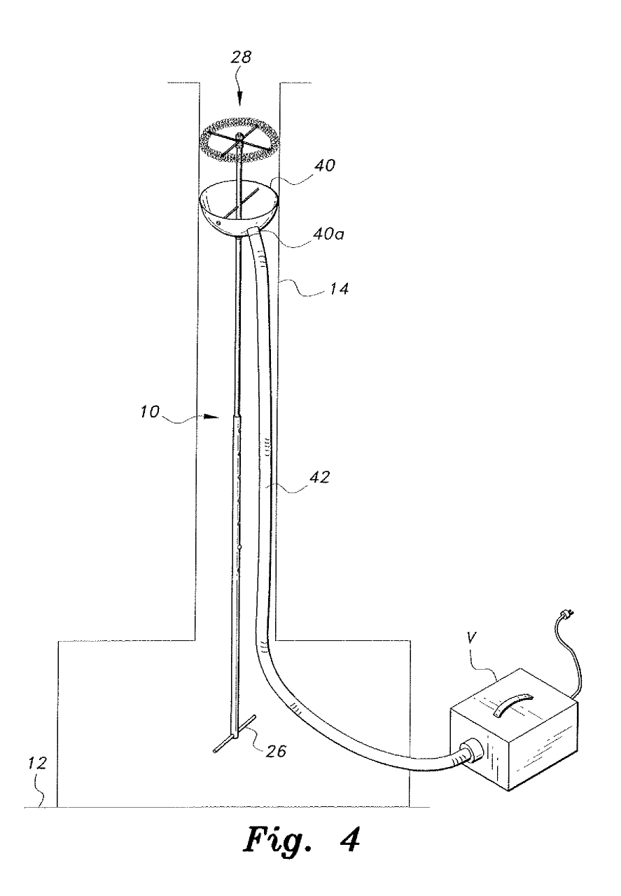

FIG. 4 shows an embodiment wherein a soot collecting receptacle 40 is provided with a funnel-type outlet 40a. A hose 42 connects the receptacle 40 to a vacuum device V. This arrangement permits the withdrawal of dislodged soot without periodically retrieving the receptacle 40.

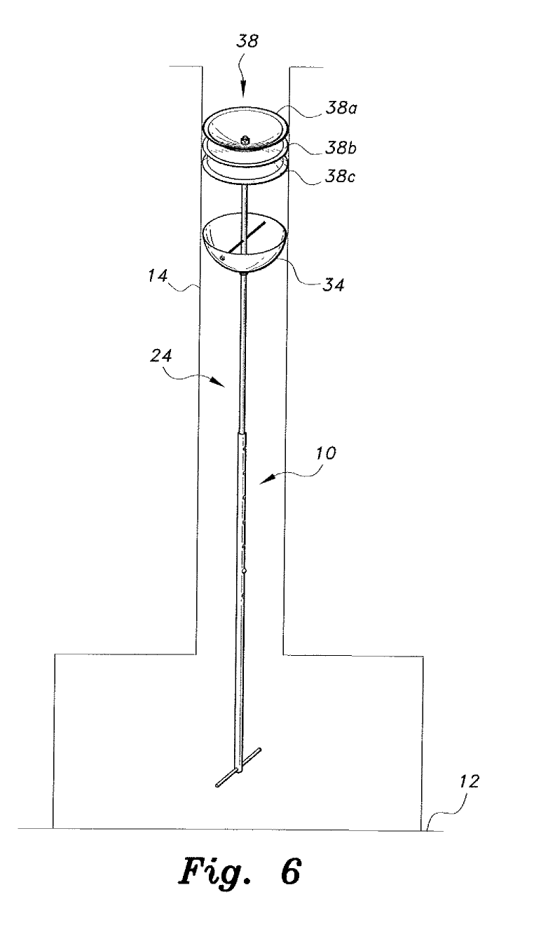

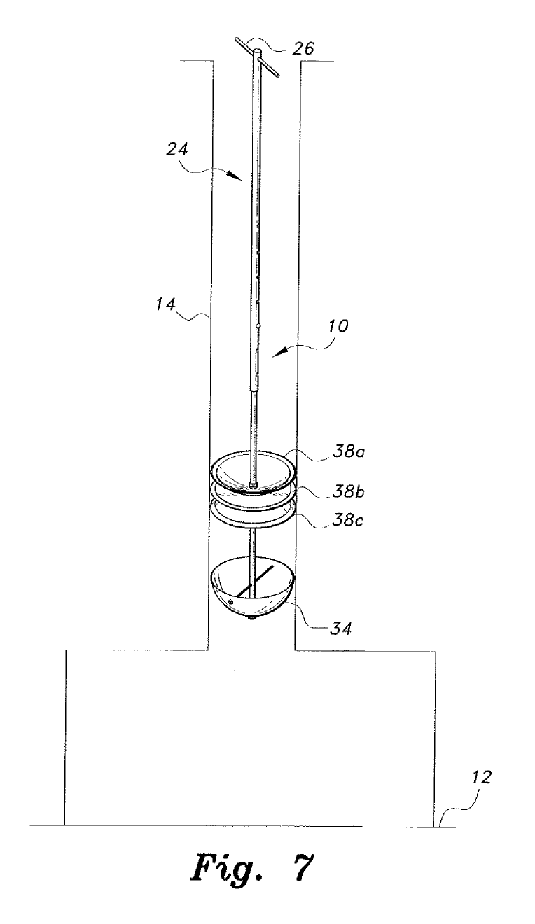

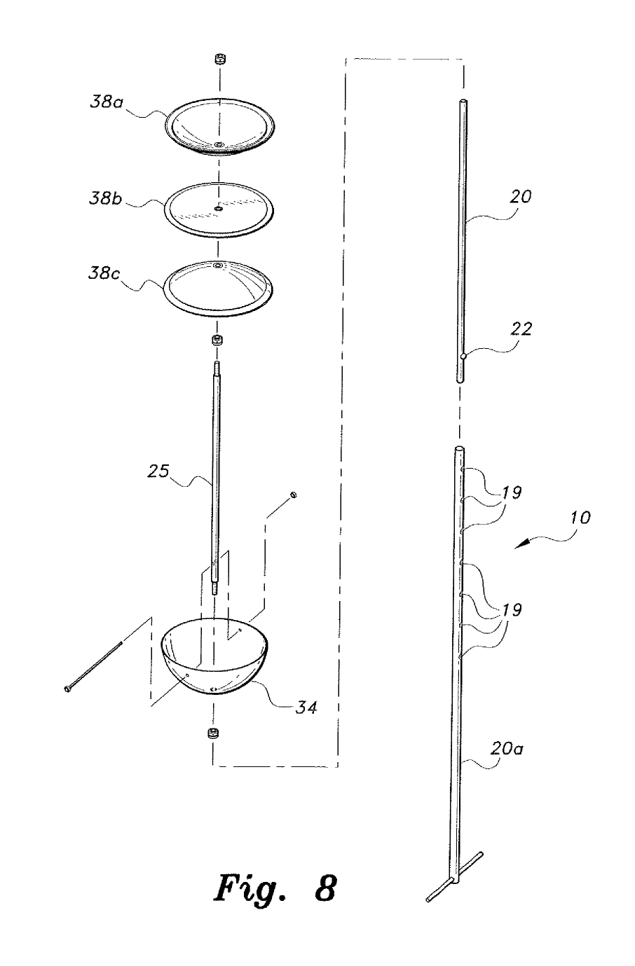

FIGS. 6-8 illustrate an embodiment of the apparatus wherein a different scrubber 38 is employed to scrape the soot from the interior walls of chimney 14. The scrubber of FIGS. 6-8 employs two circular, bowl-shaped members 38a, 38c having opposing concave and convex surfaces mounted on the handle 24. Each member 38a, 38c is provided with a sharp, circumferential edge for dislodging soot. A flat disc 38b is sandwiched between the members 38a and 38c. The disc 38b is also provided with a sharp, circumferential edge for dislodging soot. When mounted, the respective convex surfaces of members 38a and 38c are arranged to abut opposite surfaces of the flat disc 38b. This arrangement provides three scraping edges for dislodging soot from the chimney walls. The scrubber 38 can also be employed with the vacuum extraction system as described above.

It is to be understood that the present invention is not limited to the embodiments described above, but encompasses any and all embodiments within the scope of the following claims.

We claim:

1. A chimney cleaning apparatus, comprising:
a telescopically adjustable handle member having a proximal end and a distal end;
a soot scrubber member removably mounted on the handle member for dislodging soot from the chimney; and
a receptacle removably mounted on the handle member for receiving the dislodged soot therein.

2. The chimney cleaning apparatus according to claim 1, wherein, in a first configuration, said soot scrubber member is mounted at the distal end of said handle member and the receptacle is mounted between the distal end and the proximal end of said handle member.

3. The chimney cleaning apparatus according to claim 2, wherein, in an alternate second configuration, said receptacle is mounted at the distal end of said handle member and the soot scrubber member is mounted between the distal end and the proximal end of said handle member.

4. The chimney cleaning apparatus according to claim 1, wherein said soot scrubber member comprises;
an annular ring having a circumferential edge;
a plurality of metallic scrubbing wires extending from the circumferential edge of the annular ring;
a hub having a connector releasably attaching said soot scrubber member to said handle member; and
a plurality of radially extending rods attaching the annular ring to the hub.

5. The chimney cleaning apparatus according to claim 1, wherein said soot scrubber member further comprises;
a first bowl member having a sharp circumferential edge;
a second bowl member having a sharp circumferential edge; and
a flat disc having a sharp circumferential edge, the disc being disposed between the first bowl member and the second bowl member.

6. The chimney cleaning apparatus according to claim 1, wherein said receptacle defines a convex surface facing said soot scrubber for receiving the dislodged soot.

7. The chimney cleaning apparatus of claim 1, wherein said receptacle has an outlet port, the chimney cleaning apparatus further including a vacuum connected to the outlet port.

8. A chimney cleaning apparatus, comprising:
a telescopically length-adjustable handle member having a proximal end and a distal end;
a handgrip disposed at the proximate end of the handle member;
a soot scrubber member removably mounted on the handle member for dislodging soot from the chimney; and
a receptacle removably mounted on the handle member, the receptacle having a concave surface facing the soot scrubber member for receiving the dislodged soot therein.

9. The chimney cleaning apparatus according to claim 8, wherein said soot scrubber member further comprises;
an annular ring having a circumferential edge;
a plurality of metallic scrubbing wires extending from the circumferential edge of the annular ring;
a hub having a connector releasably attaching said soot scrubber member to said handle member; and
a plurality of radially extending rods attaching the annular ring to the hub.

10. The chimney cleaning apparatus according to claim 9, wherein, in a first configuration, said soot scrubber member is mounted at the distal end of said handle member and the receptacle is mounted between the distal end and the proximal end of said handle member.

11. The chimney cleaning apparatus according to claim 10, wherein, in an alternate second configuration, said receptacle is mounted at the distal end of said handle member and the soot scrubber member is mounted between the distal end and the proximal end of said handle member.

12. The chimney cleaning apparatus according to claim 8, wherein said soot scrubber member comprises;
a first bowl member having a sharp circumferential edge;
a second bowl member having a sharp circumferential edge; and
a flat disc having a sharp circumferential edge, the flat disc being disposed between the first bowl member and the second bowl member.

13. The chimney cleaning apparatus according to claim 12, wherein said soot scrubber member is mounted at the distal end of said handle member and the receptacle is mounted between the distal end and the proximal end of said handle member.

14. The chimney cleaning apparatus according to claim 12, wherein said receptacle is mounted at the distal end of said handle member and the soot scrubber member is mounted between the distal end and the proximal end of said handle member.

15. The chimney cleaning apparatus of claim 8, wherein said receptacle has an outlet port, the chimney cleaning apparatus further comprising a vacuum connected to the outlet port.

16. A method of cleaning a chimney, comprising the steps of:
inserting an adjustable cleaning tool into the chimney, the tool having a proximal end, a distal end, and a scrubber member mounted thereon;
manipulating the tool so that the scrubber member dislodges soot from inside the chimney; and
collecting soot dislodged by the scrubber member in a receptacle, the receptacle being mounted on the tool adjacent to the scrubber member.

17. The method of cleaning a chimney according to claim 16, wherein said chimney is cleaned from hearth level, the method further including the steps of:
mounting said scrubber member on the distal end of said tool; and
mounting the receptacle between the distal end and the proximal end of said tool.

18. The method of cleaning a chimney according to claim 16, wherein said chimney is cleaned from roof level, the method further including the steps of:
mounting said receptacle on the distal end of said tool; and
mounting the scrubber between the distal end and the proximal end of said tool.

19. The method of cleaning a chimney according to claim 16, further including the steps of:
attaching a vacuum system to the receptacle; and
utilizing the vacuum system to extract the dislodged soot from the receptacle.
